(19) United States
(12) Patent Application Publication
(10) Pub. No.: US 2025/0238546 A1
(43) Pub. Date: Jul. 24, 2025

(54) SYSTEMS AND METHODS OF AUTOMATED CONSENT PROCESSING FOR BIOMETRICS

(71) Applicant: Rhombus Systems, Sacramento, CA (US)

(72) Inventors: Brandon Salzberg, Sacramento, CA (US); Drew Gallatin, Sacramento, CA (US)

(73) Assignee: Rhombus Systems, Sacramento, CA (US)

(21) Appl. No.: 18/419,793

(22) Filed: Jan. 23, 2024

(51) Int. Cl. G06F 21/62; G06V 40/10; G06V 40/70

(52) U.S. Cl. CPC G06F 21/6245; G06V 40/10; G06V 40/70

(57) ABSTRACT

Systems and methods in accordance with the present disclosure relate to a system to perform automated consent processing for the collection of biometric data. The system can maintain rules associated with a zone within a field of view of the camera system. The system can detect, using image recognition techniques, that an entity has entered the zone. The system can determine if the entity has provided consent for the collection of biometric data within the zone. The system can request the consent according to the rules. The system can collect the biometric data according to at least one of the rules or the consent received from the entity.

### BACKGROUND

The present disclosure relates generally to the field of sensor systems. More particularly, the present disclosure relates to systems and methods of automated consent processing for biometrics.

Sensor systems can include one or more cameras deployed in an environment, such as by being positioned inside and/or outside of buildings. The cameras can be used to perform various operations, including but not limited to person detection and collection of biometric data, such as facial geometry or eye scans (e.g., iris scans) of a person. For example, cameras can detect a person entering a region and can collect biometric data and/or image data representative of biometric data. However, it can be challenging to collect, store, and/or process biometric data in a manner that complies with data rules and policies.

### SUMMARY

In various implementations, systems and methods in accordance with the present disclosure can be used to collect biometric data in accordance with consent of an entity including the biometric data and a set of rules. For example, the system can detect that an entity has entered a zone in which the system can collect biometric data and can prompt the entity to provide consent for the collection of their biometric data as well as conform the collection of the biometric data to a set of rules identified for the specific zone. By requesting consent from the entity and identifying the rules for the zone prior to the collection of the biometric data, the system can improve the human-machine interface as well as reduce processing time for the collection of the biometric data.

At least one aspect relates to a system. The system can include one or more processors coupled with memory. The system can determine, via an image capture device including one or more sensors, that an entity is within a zone. The system can determine that the entity is not associated with a consent to collect biometric data of the entity. The system can generate a request for the consent to collect the biometric data according to rules associated with the zone.

The system can present the request for the consent to collect the biometric data. The system can receive, from at least one of monitoring of the entity or a device associated with the entity, a response. The response can indicate acceptance of the request for the consent to collect the biometric data. The system can aggregate the biometric data according to the rules responsive to receiving the acceptance.

At least one aspect relates to a method. The method can include determining, by one or more processors coupled with memory via an image capture device, that an entity is within a zone. The image capture device can include one or more sensors. The method can include determining, by the one or more processors, that the entity is not associated with a consent to collect biometric data of the entity. The method can include generating, by the one or more processors, a request for the consent to collect the biometric data according to rules associated with the zone. The method can include presenting, by the one or more processors, the request for the consent to collect the biometric data. The method can include receiving, by the one or more processors, from at least one of monitoring of the entity or a device associated with the entity, a response indicating acceptance of the request for the consent to collect the biometric data. The method can include aggregating the biometric data according to the rules responsive to receiving the acceptance.

At least one aspect relates to an image capture device. The image capture device can include one or more sensors and one or more processors. The one or more processors can determine that an entity is within a zone. The one or more processors can determine that the entity is not associated with a consent to collect biometric data of the entity. The one or more processors can generate a request for the consent to collect the biometric data according to rules associated with the zone. The one or more processors can present the request for the consent to collect the biometric data. The one or more processors can receive, from at least one of monitoring of the entity or a device associated with the entity, a response. The response can indicate acceptance of the request for the consent to collect the biometric data. The one or more processors can aggregate the biometric data according to the rules responsive to receiving the acceptance.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts a schematic diagram of an example of an environment in which a camera is provided;

FIG. 2 depicts a block diagram of an example of a sensor system;

FIG. 3 depicts a flow diagram of an example of a method of processing consent for collection of biometric data according to rules; and

FIGS. 4A and 4B depict block diagrams of an example of a computing environment.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Sensors can be deployed in various environments to capture or detect information regarding the environment. For example, cameras can be deployed in various environments to capture images, including image frames and video or other sequences of videos, of areas in fields of view of the cameras. For example, cameras can be mounted to structures inside and/or outside of buildings. The cameras can be positioned to monitor areas or zones including, for example and without limitation, rooms, entryways, doorways, halls, access control points (e.g., gates or turnstiles), or windows.

The cameras can include various forms of image processing capabilities and/or be capable of transmitting detected images or image data thereof to one or more remote devices or systems. For example, one or more processors of one or both of a camera or a remote device communicatively coupled with the camera can perform various computer vision or other image processing operations on the image data. Such operations can include, for example and without limitation, event detection, motion detection, object detection, person detection, edge detection, shape detection, data detection or various combinations thereof. Various sensors can be used to detect sensor data including image data or non-image data, including but not limited to various image, audio, thermal, weight/mass, or other sensors may also be used to detect information regarding the environment and/or persons in the environment.

In some instances, the data detection can include detecting biometric data associated with a person or entity in a zone in the environment, such as within a field of view of the camera, or within a range of detection of a sensor. For example, the camera (or remote device) can process the sensor data to determine whether the sensor data includes biometric data, such as facial geometry, gait, fingerprints, voiceprints, or an eye scan, among others; similarly, the sensor data can be processed to retrieve the biometric data, or to provide the sensor data to further devices or systems for retrieval and/or detection of biometric data. For example, a camera can be used to determine or identify the biometric data within the image data and collect the biometric data associated with the entity.

Various data management criteria can apply to biometric data collection, storage, and/or processing. For example, any of various dynamic factors associated with location of the collection, storage, and/or processing, temporal and/or location criteria relating to when or where the data is collected, data elements indicating consent for collection being accurately, timely (or stale), and/or accessible, or various combinations thereof can make it challenging for the sensors or devices coupled with the sensors to properly detect biometric data from sensor data. In some cases, collection of biometric data for an entity can be subsequent to providing consent for the collection of the biometric data. Furthermore, criteria for the collection, processing, and storage of the biometric data can change according to the various laws and regulations specific for the region. For example, an entity in one zone may have their data collected without consent according to rules of the one zone, and an entity in a second zone may have their data collected subsequent to receiving consent and subject to rules of the second zone.

In some instances, the camera can detect motion, lines, people, or objects within a zone. The camera can include one or more sensors to detect entities within the zone. The processor(s) of the camera and/or remote device can detect an entity in the zone and collect biometric data of the entity using one or more sensors of the camera and/or remote device. Various sensors can detect motion, light, temperature, sound, or other qualities associated with the entity. For example, the camera can detect motion within the zone or near the perimeter of the zone, heat or infrared rays associated with an entity, line detection or shapes associated with an entity, or a sound corresponding to a voice of the entity, among others.

The processor(s) of the camera and/or remote device can execute any of various image processing operations, including computer vision, to detect an entity in a zone and collect biometric data of the entity. For example, various computer vision processes of the camera can identify biometric data of the entity within the zone from images captured of the zone by comparing image data amongst various images to detect differences or changes between the images, or parameters or features thereof (e.g., brightness, color, edges, shapes, etc.), that may be indicative of the entity. In some implementations, the camera or remote device can implement computer vision processes to determine biometric data of the entity within the zone based on the detections by the sensors. For example, the processors of the camera and/or remote device can perform facial recognition, retinal scans, or fingerprint identification, among others, to identify the presence of biometric data and to collect the biometric data of the entity using images, sounds, or other detections captured by the sensors.

The processor(s) of the camera and/or remote device can generate a request for collection, processing, and/or storage of the biometric data for each entity detected within the zone. An entity may confirm or deny the request for collection of his biometric data. A device associated with the entity can present a prompt to provide a response to the request upon a detection by the camera that the entity has entered a zone in which the camera can collect the biometric data. Upon providing a confirmation or acceptance of the request, the sensor can identify the rules for collection of biometric data associated with the zone and can collect the biometric data in accordance with the acceptance of the request and/or the rules. Upon providing a denial of the request, the sensor can prevent a collection of the biometric data of the denying entity in accordance with the denial of the request and/or the rules associated with the zone.

Systems and methods in accordance with the present disclosure can more accurately determine rules for the collection of biometric data and apply the rules responsive to processing the sensor data. For example, systems and methods in accordance with the present disclosure can identify that a zone in a field of view of a camera is associated with rules for data collection based on one or more of a location of the zone, a remote database, and/or preconfigured rules. In some implementations, a sensor system can determine that an entity has entered the zone and can trigger the sensor system to identify the rules. For example, the sensor system can determine that an entity within the zone has or has not consented to having his biometric data collected, responsive to determining that the entity includes biometric data. The sensor system can generate a request for consent and provide the request, such as to the entity or generally within the zone. For example, the sensor system can generate the request with instructions to play the request via a loudspeaker associated with the system, on an application operating on a client device, to present on a display device within the zone, among others. The sensor system can accept a response to the request, such as by monitoring the entity for the response or by receiving the response from an outside device such as the display device within the zone or via the application operating on the client device. Responsive to receiving an acceptance of the request to collect the biometric data, the sensor system can capture one or more images according to a set of rules configured for the collection of the biometric data. For example, the sensor system can collect the biometric data in accordance with conditions indicated in the response, in accordance with regulations associated with the zone, or in accordance with regulations associated with a location of the zone. As such, the sensor system can identify rules for the collection of the biometric data and receive consent for the collection of the biometric data to enable customization of the collection of biometric data based on at least one of conditions set by the entity or rules associated with the zone. The sensor system can update a data collector, such as a rules generator or rules engine, that executes the collection of the biometric data responsive to updating the rules for the zone and consent for the entity. The sensor system can receive or retrieve the updated rules from one or more of a remote database, or user input, among others, by which to collect the biometric data. The sensor system may update the rules responsive to a change in the entity, the rules, the zones, or receipt of user input (e.g., from a building manager) including a change to the rules. The sensor system can maintain a repository of the rules in association with an entity or zone to determine when and which rules to apply for the collection of the biometric data. The sensor system can receive the user input indicating a rule and/or change to a rule, and can validate the change according to location (e.g., jurisdiction) based rules (e.g., can output an alert or an indication of a mismatch between the request and the applicable rules).

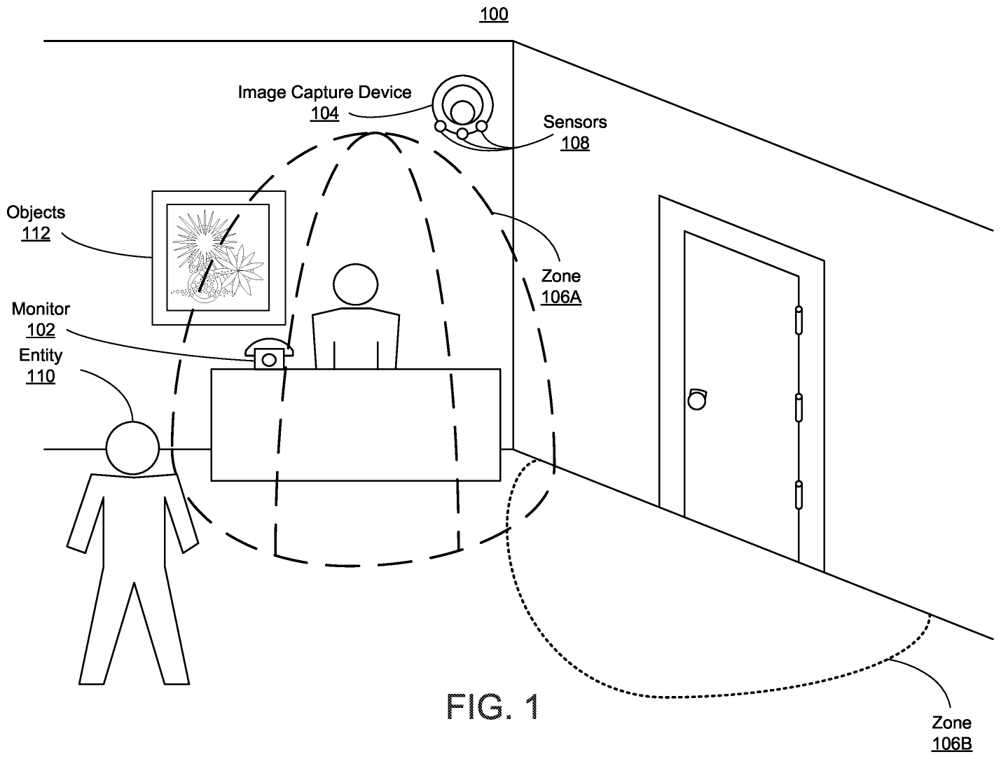

FIG. 1 depicts an example of an environment 100 in which an image capture device is provided. The environment 100 can be any setting, location, or place in which an image capture device is provided to capture images of the environment 100. For example, the environment 100 can include or be an office space, a room of a building, a hallway, manufacturing facility, storage space, medical facility, or an outdoors area such as a pavilion or walkway, or any combination thereof. The environment 100 can include objects 112 within it such as furniture, walls, windows, fixtures, or other such static or moving objects 112; as described further herein, images captured by the image capture device 104 may include image data indicative of the objects 112 or features thereof, such as edges, segments, shapes, colors, or other optical or visual features, characteristics, or parameters.

The environment 100 can include an entity 110. The entity 110 can be or include one or more people, animals, groups of persons, or other such persons or animals. The entity 110 can include a body and behaviors. The body can include arms, legs, a face, head, eyes, fingers, hands, feet, legs, among other body parts. The behavior can include motions associated with the body (e.g., gait, facial movements, gesticulations) as well as sounds or speech patterns. The body and behaviors of the entity 110 can be analyzed to determine biometric data of the entity. The entity 110 can enter into a zone 106A or 106B.

The zones 106A or 106B (generally referred to as the zone(s) 106 or 106A-N) can be or include a demarked location, region or perimeter within the environment 100. The zone 106 can be any size, shape, or volume. For example, the zone 106 can be three-dimensional (3D) (e.g., such as the zone 106A occupying a length, width, and height of the environment 100), two-dimensional (2D) (e.g., such as the zone 106B occupying a length and width of a floor or other plane of the environment), or one-dimensional (1D) (e.g., such as a point within the environment 100). The zone 106 can be included in a field of view of an image capture device. The zone 106 can be indicated by one or more of the objects 112, such as a desk or door. The zone 106 can be indicated by one or more lights, such as one or more lights coupled with an image capture device or otherwise of the environment 100. For example, the zone 106 can be indicated by one or more light-emitting diodes (LEDs).

The environment 100 can include an image capture device 104 coupled with sensors 108. In brief overview of the system, the sensors 108 can detect a parameter indicative of the entity 110 within the zone 106 and/or the biometric data of the entity 110 whereby the image capture device 104 can perform various operations according to the parameter detected by the sensors 108. These operations can include collection of the biometric data, generation of a request for consent, or activating a light, among others. As an illustrative example, the image capture device 104 may capture images of the entity 110 responsive to the sensors 108 detecting audio (e.g., sound(s) indicative of audio). The image capture device may determine that the detected audio corresponds to a verbal acceptance of a request for consent. Additionally or alternatively, the image capture device 104 may generate the request for consent for collection of the biometric data responsive to or concurrent with a detection of movement within the zone 106 by the sensors 108.

The image capture device 104 can be a visible light camera (e.g., color or black and white or grayscale), infrared camera, ultraviolet camera, or combinations thereof. The image capture device 104 can be a video camera. The image capture device 104 can include one or more lenses, of which a zoom function can be controlled. The image capture device 104 can include a lens to receive light corresponding to a field of view of the image capture device 104 and to provide the light to an image sensor of the sensors 108 that generates one or more images based on the received light. The image sensor 108 can provide image data including the one or more images (or video, or an image stream) to any processors and/or communications circuitry of the image capture device 104. The image sensor 108 can include sensor circuitry, including but not limited to charge-coupled device (CCD) or complementary metal-oxide-semiconductor (CMOS) circuitry, which can detect the light received via the lens and generate images based on the received light.

The image capture device 104 can receive light from the environment 100 and generate images and/or image data based on the received light. The image capture device 104 can have respective fields of view. The field of view can correspond to a region of the environment 100 from which a lens or sensor (e.g., the sensors 108) receives light to generate images. The image capture device 104 can capture still images or videographic information of any sort and may capture image or videographic information with the application of a variety of filters (such as, for example, filters that enable to ability to capture images or video at night). In some implementations, the image capture device 104 can be an infrared camera, a visible light camera, or any combination thereof. The image capture device 104 can output video data, image data, or image stream data.

The image capture device 104 can be positioned in the environment 100 such that its field of view can include images of the whole environment 100 or an area or portion of the environment 100 such as the zone 106. For example, the image capture device 104 can be positioned within the environment 100 such that the image capture device 104 can capture images of the objects 112 within the environment 100, such as an egress (e.g., a door or window) or furniture. The image capture device 104 can be positioned to capture images of persons or animals within the environment 100, such as the entity 110. In some implementations, the zone 106 can coincide with or be determined by the field of view of the image capture device 104. For example, the entirety of the field of view of the image capture device 104 can be the zone 106, or a portion of the field of view can be the zone 106.

The image capture device 104 can be fixed to a structure in the environment 100, such as walls, ceilings, doors or door frames, struts, or rails in the environment 100. The image capture device 104 can be stationary or mobile. The image capture device 104 can be adjustable in position or orientation, such as being adjustably fixed to a structure in the environment 100. For example, the image capture device 104 can include or be coupled with a drive (e.g., any of a motor, gears, linkages, or combinations thereof) that can be used to adjust at least one of a pan angle or tilt angle of the image capture device 104. The image capture device 104 can be adjusted in position or orientation manually or responsive to control of the drive. The image capture device 104 can be adjusted to orient the field of view towards an area of the environment 100, such as the zone 106. The image capture device 104 can have predetermined resolutions or fields of view.

The image capture device 104 can be coupled with the sensors 108 to detect or capture the images and/or to provide non-image related detections. The sensors 108 can be coupled with the image capture device 104. The sensors 108 can be attached to a surface of the image capture device 104 or mounted on the image capture device 104 such that sensors 108 can detect one or more attributes of the environment 100, such as light, movement, moisture, temperature, or sound. For example, the sensors 108 can include light sensors 108 to detect light of the environment 100. The light sensor 108 can be any sensor configured to detect light intensity or brightness, such as a photoresistor, photodiode, or phototransistor. The light sensor 108 can detect light in the visible light spectrum or the invisible light spectrum (e.g., infrared or ultraviolet light). The light sensor 108 can detect an amount of light (e.g., in lumens, lux, degrees Celsius, etc.) within the environment 100. The image capture device 104 can capture images in conjunction with the light sensor 108. For example, the image capture device can adjust a capture of the images of the environment based on the detection from the light sensors 108.

The sensors 108 can include motion sensors 108 to detect movement within the environment 100. The motion sensors 108 can include sensors such as passive infrared sensors (PIR), ultrasonic sensors, accelerometers, gyroscopes, or microwave sensors, among others, to detect movement within the zone 106 or on a perimeter of the zone 106. In some implementations, a detection of movement can indicate an entity entering, leaving, or within the zone 106. The motion sensors 108 can be coupled with the image capture device 104 to detect a motion of the entity 110 related to the behavior and/or body of the entity 110. For example, a motion of the entity 110 can indicate that the entity 110 is a human entity. For example, detecting a motion of the entity 110 by the sensors 108 can include a detection of a gait, gesticulation, particular body movements (e.g., movements of the head or eyes), or movements of the object 112 (e.g., carrying or otherwise moving the object 112) by the entity 110, among others.

The sensors 108 can include temperature sensors 108 to detect heat or temperature within the environment 100. The temperature sensors 108 can include sensors such as thermocouples, resistance temperature detectors (RTDs), thermistors, or infrared (IR) sensors, among others, to detect a temperature or a change in temperature within the zone 106. In some implementations, a detection of a change of temperature or a temperature within a threshold can indicate the entity 110 entering, leaving, or within the zone 106. In some implementations, if the sensors 108 detect a region of the zone 106 to be within a threshold temperature, the image capture device 104 may capture images of the region corresponding to the threshold temperature.

The sensors 108 can include sound or vibration sensors to detect sound or noise of the environment 100. The sound sensors 108 can include sensors such as microphones, accelerometers, piezoelectric sensors, or laser doppler vibrometers, among others. In some cases, the sound sensors 108 (such as a microphone) can be coupled with the image capture device 104. In some implementations, a detection of a vibration of the ground or the object 112, or a detection of a sound or voice can indicate an entity entering, leaving, or within the zone 106.

In some implementations, the sensors 108 can transfer a measurement of the one or more attributes to the image capture device 104 or to other devices of a sensor system and the sensor system can perform an operation based at least on the detected attribute. For example, if the image capture device 104 determines the light detected by the light sensor 108 to be insufficient for capturing images or below a threshold light level, the image capture device 104 can turn on or activate one or more light sources. For example, if the image capture device 104 determines that a source of heat detected by the temperature sensor 108 within the zone 106 is between a threshold temperature (e.g., such as 95-104° F.), the image capture device 104 may generate a request for consent for collection of the biometric data. In some implementations, the image capture device 104 can use one or more different sensors 108 to make a determination. For example, a light sensor 108 and a motion sensor 108 can detect a movement which blocks or obfuscates a light within the environment. The image capture device 104 may determine that an entity 110 has entered the zone 106 based on levels of movement and light provided by the detections from the light and motion sensors 108.

In some implementations, the image capture device 104 may be coupled with at least one monitor 102. The monitor 102 can be or include any input and/or output device to provide instructions, indications, or presentations within the environment 100. For example, the monitor 102 can provide to an entity 110 a presentation of a request for consent for collection of biometric data. The monitor 102 can include a loudspeaker, such as any device designed or configured to emit audio. The loudspeaker can include a magnet, cone, audio amplifier, or other such devices to produce mechanical vibrations to output sound from a signal. In some embodiments, the loudspeaker can be coupled with or include a transducer. For example, the loudspeaker and the transducer may be part of the same speakers, headphones, earbuds, or other device to transform an electrical signal to audio and produce output audio. In some implementations, the image capture device 104 can generate instructions for a transducer to provide an electrical signal to the loudspeaker to produce an auditory request for consent, a warning signal, or other auditory output from the monitor 102.

The monitor 102 can be or include a display device, such as a screen, to provide visual presentations such as images, text, or videos. The display device can be or include a touchscreen, projector, LED screen, virtual reality (VR) device (e.g., a VR headset), or any other combination of hardware and software to provide visual presentations. In some implementations, the image capture device 104 can generate instructions for the display device to present a visual request for consent, a warning message, or other visual output from the monitor 102.

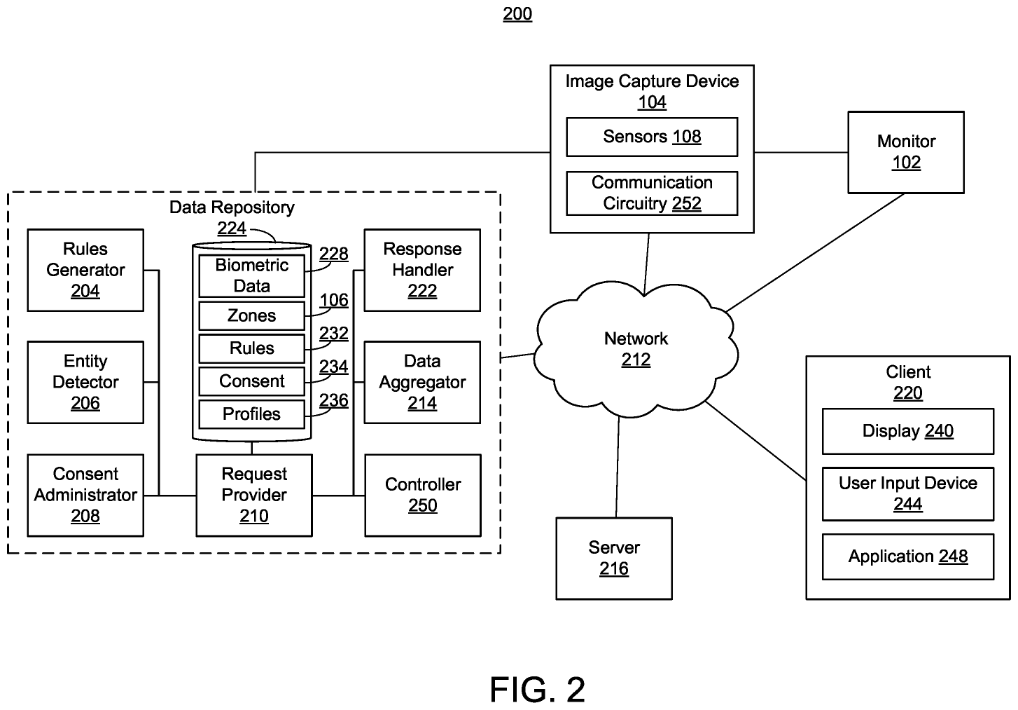

FIG. 2 depicts an example of a sensor system 200. The sensor system 200 can include any hardware or software configurable to detect an entity within a zone, identify a set of rules for the zone, determine if the entity is associated with a request for consent, provide a request for consent, receive a response indicative of the request for consent, and collect biometric data according to the set of rules associated with the zone. The sensor system 200 can include at least one of a rules generator 204, an entity detector 206, a consent administrator 208, a request provider 210, a response handler 222, a data aggregator 214, a controller 250, a network 212, a server 216, the image capture device 104, the monitor 102, a client 220, or a data repository 224. As depicted herein, the components of the system 200 can include or refer to any of the components or functionalities thereof depicted in the systems and methods of FIG. 1, 3, or 4. Various components of the system 200, including but not limited to the entity detector 206 and consent administrator 208, can include any one or more functions, operations, algorithms, source code, binary or computer-executable instructions, machine learning models, rules, heuristics, or various combinations thereof to enable such components to perform various operations described herein, including but not limited to computer vision operations. For example, while various operations are described in the context of the sensor system 200 causing actions responsive to evaluation of rules 232, any of various operations described herein can be performed responsive to processing data using one or more functions, operations, algorithms, source code, binary or computer-executable instructions, machine learning models, rules, heuristics, or various combinations thereof.

The image capture device 104 can include at least the sensors 108 or communication circuitry 252. The communications circuitry 252 can be used to communicate data such as sensor data (e.g., from the sensors 108). The sensor data can include image data (e.g., from images captured by the image capture device 104 in conjunction with the sensors 108), audio or sound data (e.g., noises or vibrations captured by a sound sensor 108), electromagnetic data (e.g., frequency, energy, or amplitude of light, temperature, radio, ultraviolet, or other such electromagnetic waves), among others. The communications circuitry 252 can communicate the sensor data with other image capture devices and remote devices (e.g., via the network 212). The image capture device 104 can use various communication protocols to communicate with various devices, systems, or networks, such as Bluetooth, Bluetooth low energy (BLE), Zigbee, Z-wave, near filed communication (NFC) or WiFi protocols. The communications circuitry 252 can include a cellular transceiver or a cellular modem configured to communicate with a cellular network. The communications circuitry 252 can include a WiFi transceiver for communicating via a wireless communications network. The communications circuitry 252 can communicate via local area networks (e.g., a building LAN), WAN (e.g., the Internet, a cellular network), or conduct direct communications (e.g., NFC, Bluetooth, BLE, Zigbee, Z-wave). The communications circuitry 252 can conduct wired or wireless communications. For example, the communications circuitry 252 can include one or more wireless transceivers (e.g., a WiFi transceiver, a Bluetooth transceiver, a BLE transceiver, an NFC transceiver, a cellular transceiver). The communications circuitry 252 can be coupled with at least one antenna that the communications circuitry 252 uses to receive and transmit data. The communications circuitry 252 can communicate with the various components of the sensor system 200 via the network 212.

The various components of the sensor system 200 can communicate via the network 212. The network 212 can be any wireless or wired network to facilitate communication, data transfer, transmission, reception, or connection among the components of the sensor system 200 or between components of the sensor system 200 and outside systems. The network 212 can include any kind of communications link, cable, transmitter, receivers, transceiver, antenna, logic circuit, communication chip, communication network (e.g. a local area network (“LAN”), a wide area network (“WAN”), or an inter-network (the internet), or cellular network (e.g., 3G, 4G, or 5G)). The network 212 can be a private network or a public network. Access to or communication through the network 212 can be accessible for all in a public network. Access to or communication through the network 212 can be restricted for a private network. Restriction for a private network can include the private network restricted to a subset of devices, devices subject to authorization by, for example, security credentials or authentication service, or the private network restricted to specific communications protocols or encryption standards. The network 212 can allow for communication with or between the image capture device 104, the rules generator 204, the entity detector 206, the consent administrator 208, the request provider 210, the response handler 222, the data aggregator 214, the data repository 224, the monitor 102, the server 216, or the client 220.

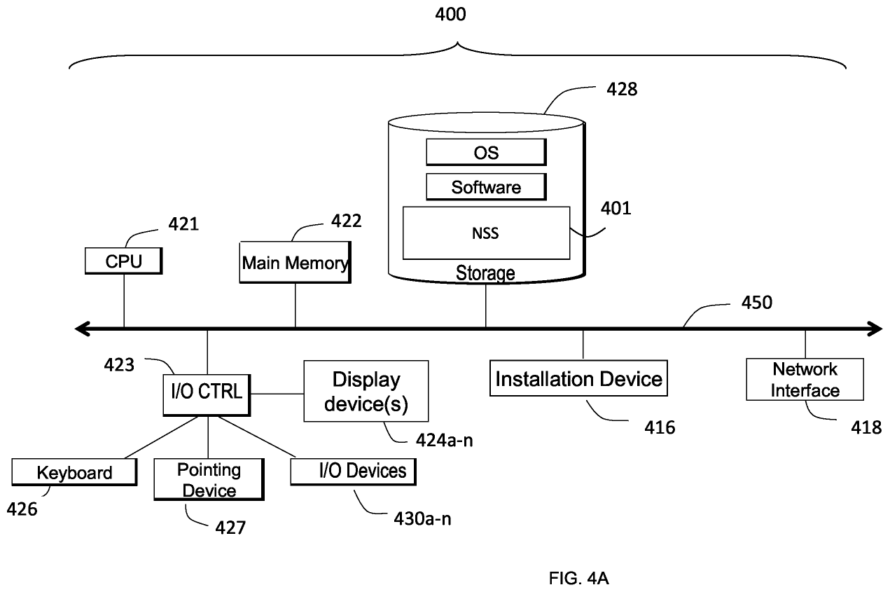

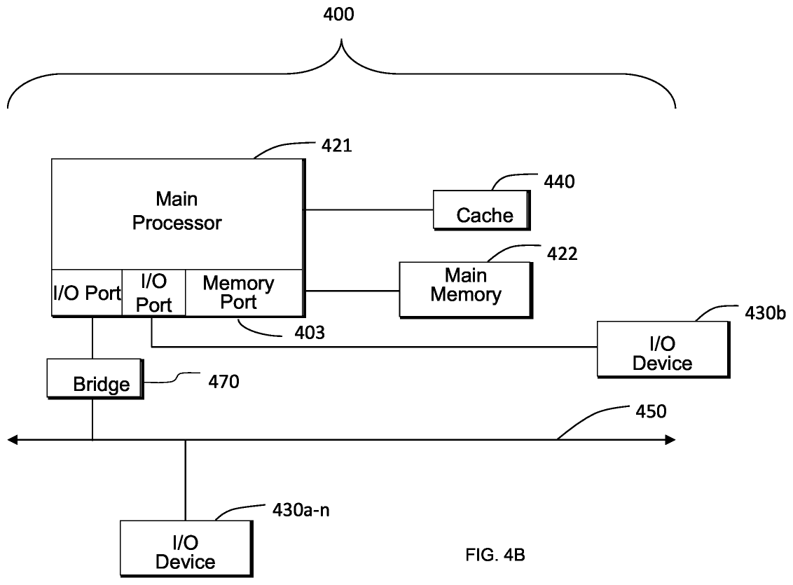

The sensor system 200 can include, access or otherwise communicate with or utilize one or more clients 220 (e.g., client devices). The client 220 can be any combination of hardware and software to communicate with components of the sensor system 200, such as the request provider 210 or the image capture device 104. The client 220 can be a device internal to the sensor system 200, or the client can be external to the sensor system 200. The client 220 can include one or more systems, components or functionalities of the computing system 400 depicted in FIG. 4. The client 220 can include a display 240, a user input device 244 (hereinafter referred to as the UI device 244), or an application 248. The client 220 can refer to or include a mobile computing device, such as a smartphone, wireless telecommunications device, tablet, or wearable computing device (e.g., smart watch or smart glasses), a personal computer (e.g., laptop, desktop, tablet, workstation), an appliance with computing capabilities (e.g., a smart television or refrigerator), or other such computing device configured to perform the functions described herein. In some cases, the client 220 can refer to or include a smart card, such as a physical card that includes an embedded integrated chip.

The client 220 can communicate with one or more components or systems of the sensor system 200 by, for example, the network 212 or the communications circuitry 252. The client 220 can communicate with one or more systems or components of the sensor system 200 including, for example, the server 216, the image capture device 104, the consent administrator 208, the request provider 210, the response handler 222, or the data repository 224. The client 220 can receive a request or provide a response to any of the components of the sensor system 200. For example, the client 220 can receive a request from the request provider 210 to present on the display 240 via the application 248 operating on the client 220. For example, the client 220 can transmit a response via the application 248 of the client 220 to provide acceptance or denial of a request for consent. The client 220 can receive a request or information from any of the components of the sensor system 200. For example, the client 220 can receive information via the application 248 operating on the client 220 to present on the display 240 of the client 220.

The client 220 can host, execute, or run the application 248. The client 220 can launch or invoke the application. The application 248 can be provided by a manufacturer of the sensor system 200 or the image capture device 104. For example, the client 220 can download the application 248 via an online application store or marketplace. The application 248 can be developed or provided by the manufacturer of the image capture device 104 or by an outside party. The manufacturer of the image capture device 104 can configure the application 248 to communicate or interface with the image capture device 104, the consent administrator 208, the request provider 210, the response handler 222, or the monitor 102. The client 220 can execute the application 248 to cause the application to communicate with the image capture device 104 via the communication circuitry 252 of the image capture device 104.

The client 220 can include a display 240. The display 240 can be any screen coupled with the client 220 to display at least the application 248. The display 240 can include a touch screen, organic light-emitting diode (OLED), or liquid crystal display (LCD), among others. In some implementations, the client 220 can receive from components of the sensor system 200, such as the request provider 210, instructions to present on the display 240 via the application 248 executing on the client 220. For example, the request provider 210 can send an indication or message to present on the display 240. In some implementations, the display 240 can include the UI device 244.

The client 220 can include a user input (UI) device 244. The UI device 244 can be any device coupled with the client 220 to accept input to the client 220. The UI device 244 can include a keyboard, mouse, button, microphone, controller (e.g., joystick or video game controller), or haptic device to transfer input from a user of the client 220 to the client 220. The UI device 244 can include or be coupled with the display 240. For example, the UI device 244 can be a touchscreen which presents on the client 220 as well as accepts input. In some implementations, the client 220 can receive input from the UI device 244 to control or communicate with the components of the sensor system 200, such as the image capture device 104 or the response handler 222. In some cases, the client 220 can accept settings for operation of the sensor system 200 via the UI device 244, or the client 220 can modify or provide the settings for operation of the sensor system 200 via the UI device 244. In some cases, the UI device 244 can accept input to download the application 248 from, for example, the server 216.

The server 216 can refer to one or more computing systems which facilitates communications between the components of the sensor system 200 or an external computing system. The server 216 can be or include one or more components or functionality of a computing system, including, for example, one or more processors and memory. The server 216 can refer to or include a cloud computing environment. The server 216 can communicate with the components of the sensor system 200 via network 212. For example, the server 216 can receive data or transmit data to the image capture device 104, the rules generator 204, the entity detector 206, or the other components of the sensor system 200. The server 216 can provide instructions, software, or commands to the sensor system 200 to facilitate an identification of rules 232 for the collection of biometric data 228. The server 216 can update or add to the data repository 224.

The data repository 224 can be any memory, storage, or cache for storing information or data structures that facilitates the sensor system 200 to receive consent from an entity to collect biometric data. The data repository 224 can contain any information about the sensor system 200 and can allow that information to be accessed or read by any components of the sensor system 200. The image capture device 104, the rules generator 204, the entity detector 206, the consent administrator 208, the request provider 210, the response handler 222, or the data aggregator 214 or the server 216 can write information to the data repository 224. The data repository 224 can store, maintain, or otherwise include data such as biometric data 228, the one or more zones 106, one or more rules 232, consent 234, or one or more profiles 236.

The profiles 236 (also referred to generally as the user profile(s) 236 or the entity profile(s) 236) can be or include a data structure to store, update, and maintain information for one or more of the entities 110. For example, the profile 236 may include information related to identifying information of the entity, such as a name, social security number, address, employer, title, or phone number of the entity 110. The profile 236 may include trait information related to the user, such as age, sex, height, weight, location, family, allergies, profession, income, or education, among others. The profile 236 can be updated responsive to a schedule, periodically, (e.g., daily, weekly), a change in user information (e.g., input by the user via the user input device 244 or learned from the client 220), or by the sensor system 200.

The profile 236 can store and maintain information related to a user of the application 248 through client 220. Each profile 236 may be associated with or correspond to a respective entity 110 or user of the application 248. The user profile 170 may contain or store information for each zone entered by the entity 110. The information for an entity 110 may include various parameters, actions, zones 106, biometric data 228, or consent 234, and may initially be null. The profile 236 may be stored and maintained in the data repository 224 using one or more files (e.g., extensible markup language (XML), comma-separated values (CSV) delimited text files, or a structured query language (SQL) file). The profile 236 may be iteratively updated as the entity 110 enters different zones 106 or provides responses. The profile 236 may include data collected by the sensors 108, such as a heartrate, breathing pattern, or pupil dilation of the user. For example, the profile 236 may include biometric data 228 associated with the entity 110.

The biometric data 228 can be or include any information related to physical or behavioral characteristics of an entity 110 detected by at least the sensors 108. The biometric information 228 can be determined or characterized from detections by the sensors 108, including but not limited to detections of sound, light, motion, temperature, or moisture, among others. The biometric data 228 can include information related to the body of the entity 110, such as a physicality of the body, gestures of the body, or presentation of the body, among others. The body can include legs, eyes, hands, facial features, or other such components of a human or animal body. The biometric data 228 can characterize attributes of the body of the entity, behaviors of the entity, or other such distinguishing characteristics of the entity 110. For example, the biometric data 228 can include patterns of the body (such as fingerprints, iris, or retinas). The biometric data 228 can include characteristics of the facial features of the entity. The facial features of the entity can include facial expressions, position and size of the facial features (e.g., a nose, eyes, or mouth), or a motion of the facial features (e.g., a smile or speaking pattern), among others. The biometric data 228 can include geometries of the body, such as a size or shape of hands (e.g., including fingers, palms, fingernails, knuckles, etc.), feet (e.g., including toes, soles, toenails, heels, etc.), or other such body parts.

The biometric data 228 can include movements of the entity 110. For example, the biometric data 228 can characterize gesticulations of the entity 110, a gait of the entity 110, a typing rhythm (such as on a keyboard) of the entity 110, a handedness (e.g., right or left handed) of the entity 110, or a tic of the entity 110. The biometric data 228 can include sounds associated with the entity 110. For example, the biometric data 228 can include a voice (e.g., including a volume, inflection, or pitch), walking sounds, breathing pattern, heartbeat, or other sounds associated with the entity 110.

The image capture device 104 can detect or determine the biometric data 228 via a detection by the sensors 108, image processing on images captured by the image capture device 104, or a combination thereof. In some implementations, the sensors 108 can detect the biometric data 228 of the entity 110. For example, a radar sensor of the sensors 108 can detect a breathing pattern associated with the entity 110. The radar sensor 108 can detect a duration of the breathing pattern, a frequency of inhalation and/or exhalation, or a change in the breathing pattern. A temperature sensor 108 can detect a temperature of the entity 110. For example, the temperature sensor 108 can indicate that a region of the zone 106 is between a threshold temperature for a human entity 110 (e.g., 95-105° F.). Furthermore, the temperature sensor 108 can capture the temperature for an identified entity 110, such as a precise temperature (e.g., 98.7° F.) or a range of temperatures for the entity 110.

A sound sensor of the sensors 108 (e.g., a recording device or microphone) can detect and/or record a voice of the entity 110. In some implementations, the sound sensor 108 can be tuned such that it detects sounds within a threshold range, such as the threshold range of a human voice (e.g., 80-260 Hz). In some implementations, the sound sensor 108 can assign a characteristic to the entity 110 according to the frequency or frequency range of the detected sound.

In some implementations, the image capture device 104 can analyze images captured by the image capture device 104 for the biometric data 228. The image capture device 104 can capture images of the entity 110. The images can be or include any images such as still images, video, streams of images, or other such images described herein. In some implementations, the image capture device 104 can store a captured image in the data repository for access by other components of the sensor system 200. The image capture device 104 can perform various image processing functions to determine the biometric data 228 from the captured images. For example, the image capture device 104 can perform facial recognition by analyzing images including the facial features of the entity 110 to identify proportions, sizes, and the features of the entity's face. The image capture device 104 can perform analyses and processing to identify movement of entity such as facial expressions, gesticulations, eye movements, gait, or typing behaviors, among others. For example, the image capture device 104 can perform eye tracking by determining the eyes of an entity and tracking the movements of the eyes to determine locations or objects in view by the entity 110. For example, the image capture device 104 can recognize a gait of the entity, such as a stride, speed, length, or posture of the entity 110.

The image capture device 104 can utilize one or more of computer vision and/or machine learning algorithms to identify the biometric data 228 via image recognition techniques. In some implementations, the image recognition techniques can include the image capture device 104 to extract relevant features of the entity 110 from the images and compare the features against stored biometric templates. For example, the image capture device 104 can identify a nose of the entity 110 by comparing an image of the entity 110 to a series of known images of noses to identify the nose of the entity. The image capture device 104 can use machine learning algorithms such as classifiers, edge detection, or neural networks, among others, to detect the presence of the biometric data 228, identify sections within the images as reference points for the detection of the biometric data 228, and classify extracted features of the biometric data 228 from the images. For example, the image capture device 104 can determine from an image of the entity 110, a gait of the entity 110 as having a certain speed, shape, or other characteristic, and can store the specific gait associated with the entity 110 within the profile 236 of the entity to identify the entity 110. The image capture device 104 can determine from the gait of the entity a classification of the gait, such as a run, walk, or skip, based on a comparison with other gaits of the entity 110, or other entities or gaits.

The image capture device 104 can capture images of the entity 110 as a scan. In some implementations, the image capture device 104 can capture scans of fingerprints, retinas, or irises as biometric data. The image capture device 104 can employ the sensors 108 to scan a texture, patterns, or ridges of the entity 110. For example, a fingerprint sensor of the sensors 108 can employ capacitive sensing or optical sensing to capture an image of a fingerprint of the entity 110. The image capture device 104 can scan retinas, irises, or other aspects of eyes to recognize a unique pattern of an entity's eye. For example, the image capture device 104 can capture an image of the entity's eye and determine, using the image recognition techniques described herein, patterns of the colors, textures, lines, or other characteristics of the user's eye.

The image capture device 104 can be subject to rules 232 for capture, collection, storage, or processing of the biometric data 228. The rules 232 can include a set of conditions, thresholds, or other parameters for the sensor system 200 to collect the biometric data 228. Collecting the biometric data 228 can refer to or include the sensor system 200 capturing images of the entity 110. For example, collecting the biometric data 228 can include the image capture device 104 taking videos, images, streams of images, scans, or other such images of the entity 110. Collecting the biometric data 228 can refer to or include the sensor system 200 storing images of the entity 110. For example, storing the captured images of the entity 110 in the data repository 224 for a duration of time can be considered collecting the biometric data 228. Identifying the biometric data 228 can be considered collecting the biometric data 228. For example, collecting the biometric data 228 can include associating the biometric data 228 with a profile 236 of the entity 110 or another such identifier. In some implementations, processing the biometric data 228 can be considered collecting the biometric data 228. For example, processing the biometric data 228 can include performing image processing or recognition on images captured by the image capture device 104 to determine the biometric data 228. In some implementations, transmitting or transferring the biometric data 228 can be considered collecting the biometric data 228. For example, collecting the biometric data 228 can include the sensor system 200 transmitting the biometric data 228 or the images to the server 216, the data repository 224, or to a remote computing system via the network 212 or a non-transitory computer-readable medium.

The rules 232 for collecting the biometric data 228 can include rules based on the type of collection of the biometric data 228. As detailed above, the collection of the biometric data 228 can include one or more processes for the biometric data 228 or the images, such as image capture, storage, transmittal, image processing, among others. One or more rules of the rules 232 can apply to a process associated with the collection of the biometric data 228. In some implementations, a first rule of the rules 232 can indicate a time of data collections by the image capture device 104. For example, a rule can indicate a time (e.g., not between 8 AM to 5 PM, or only between 1 PM and 11 PM) at which the images can be captured, processed, stored, etc. In some implementations, the rules 232 can indicate a type of image that the image capture device 104 can capture. For example, a first rule of the rules 232 can indicate that videos may not be captured, audio may not be captured, or only still images can be captured, among others. In some implementations, a first rule of the rules 232 can indicate a duration of time for storage of the images, such as a threshold period of storage. Upon elapse of the threshold period of storage, the first rule can indicate that the sensor system 200 is to delete the image or biometric data 228 from the data repository 224. In some implementations, one or more rules 232 can apply to a transmittal of the biometric data 228 or the images. For example, a first rule of the rules 232 can indicate locations, servers, external computing devices, etc., to which the biometric data 228 or the images can or cannot be transmitted. In some implementations, one or more rules 232 can apply to a processing of the biometric data 228 or the images. For example, a first rule of the rules 232 can indicate machine learning algorithms, computer vision, or other image recognition techniques to be applied or not applied to the biometric data 228 or the images.

The rules 232 for collecting the biometric data 228 can include rules based on a type of entity associated with the biometric data 228. In some implementations, the rules 232 can indicate data collection for one or more types of entities. The types of entities can include an age of an entity, sex of an entity, citizenship of an entity, among others. For example, a first rule of the rules 232 can indicate that the sensor system is not to capture biometric data for a child under the age of 18. In some implementations, a first rule of the rules 232 can indicate that the sensor system is not to collect biometric data or collect the biometric data 228 subject to conditions for entities possessing citizenship for a first country.

In some implementations, the sensor system can collect the biometric data 228 for an entity to determine to no longer collect the biometric data for the entity. For example, the sensor system 200 may first determine an age of the entity using image recognition techniques. Upon a determination that the entity is under a threshold age, the sensor system 200 may cease collection of the biometric information for the entity under the threshold age and may delete some, none, or all of the biometric information collected for the entity in order to determine the age of the entity.

The rules 232 for collecting the biometric data 228 can include rules based on a type of biometric data 228. In some implementations, the rules 232 can include rules to collect, prevent collection, or collect some of the biometric data 228 based on a type of the biometric data 228. The type of the biometric data 228 can include biometric data relating to a body part of the entity, such as the entity's eyes, ears, face, hands, arms, or legs, among others. For example, a first rule of the rules 232 can indicate that the sensor system 200 is not to collect retinal scans of an entity within the zone 106, and a second rule can indicate that fingerprint scans are permissible for the entity within the zone 106. The type of the biometric data 228 can include biometric data relating to a behavior or movement of the entity 110, such as a gait, eye movement, gesticulation, or facial expression. For example, a first rule of the rules 232 can indicate that collection of biometric data 228 related to the gait of the entity 110 can be collected, while a second rule of the rules 232 can indicate that the sensor system 200 can not collect eye movements or eye tracking of the entity 110.

Identification of the rules 232 for the zone 106 can be determined by the rules generator 204. The sensor system 200 can include at least one rules generator 204. The rules generator 204 can include any hardware or software configurable to determine which rules of the rules 232 to identify, adhere to, or otherwise apply for the collection of the biometric data 228 based on at least one of the zone 106 or the entity 110, including formatting of audio and/or speech used to request consent (e.g., to allow for configurable consent according to location, regulation, and/or jurisdiction information). The rules generator 204 can generate or establish the rules 232. The rules generator 204 can operate or cause the performance or prevention of certain functionalities of the sensor system 200 based on the identified rules 232.

In some implementations, the rules generator 204 can identify the rules to apply based on the zone 106. In some cases, some zones 106 may be in certain locations which regulate, legislate, or otherwise provide regulations for the collection of biometric data 228. For example, a country, locality, city, state, or other jurisdiction can include laws or regulations for the collection of biometric data 228. The rules generator 204 can identify, select, determine, or otherwise generate the rules for the zone 106 based on the laws or regulations associated with a location of the zone. For example, the rules generator 204 can access or retrieve a remote server, computing device, or database including laws or regulations related to the collection of biometric data. The rules generator 204 can generate the rules 232 to apply based on information retrieved from the accessed database including laws or regulations related to the collection of biometric data. For example, the rules generator 204 can access a database for a first locality and can generate rules for zones 106 within the first locality based on information contained in a remote database for the first locality related to the collection of biometric data.

The rules generator 204 can generate the rules 232 to apply for the zone 106 based on input received from a remote device, such as the server 216. In some implementations, the server 216 can transmit one or more of the rules 232 to the rules generator 204. The rules generator 204 can store the received rules 232 in the data repository 224. The rules generator 204 can determine a subset of zones of the zones 106 on which to apply the received rules 232. In some implementations, the server 216 can transmit an indication of a subset of zones of the zones 106 at which to apply the received rules 232. The rules generator 204 can generate the rules 232 to apply to the zone 106 based on input received by the sensor system 200. In some implementations, the sensor system 200 can receive input via the client 220. The input can include one or more rules 232 to apply to one or more of the zones 106.

The rules generator 204 can identify the rules based on a type of the zone 106. The zone 106 can be or include a type such as a public setting, private setting, home setting, office setting, or medical setting, among others. In some cases, certain types of zones 106 can be subject to laws or regulations for that type of zone. For example, a zone in a doctor's office can be subject to regulations under the Health Insurance Portability and Accountability Act (HIPAA) and the rules generator 204 can select the rules for that zone in accordance with HIPAA. The rules generator 204 can retrieve the rules 232 from a remote location (e.g., the server 216 or a remote database), or identify the rules 232 from the data repository 224 based on the type of the zone 106.

In some implementations, the rules generator 204 can identify a first set of rules for a first zone 106A and a second set of rules for a second zone 106B within the same environment. For example, there can be one or more zones 106 within an environment (e.g., the environment 100). The one or more zones 106 can overlap, abut, or be separate. In some implementations, the rules generator 204 can identify a first set of rules for the first zone 106A and the second set of rules for the second zone 106B. The first and second set of rules can include the same rules, different rules, or a combination thereof. In some implementations, the rules generator 204 can determine a sequence to apply the rules 232. The sequence of rules 232 can indicate an order, duration, or pattern with which to apply the identified rules 232. The sequence can indicate one or more rules are to be applied in parallel, sequentially, or in other orders and combinations.

The identified rules 232 can indicate to the rules generator 204 to generate instructions to provide to the sensor system 200. In some implementations, the rules generator 204 can perform various operations based on the identified rules 232. The rules generator 204 can generate instructions to provide to at least the entity detector 206, the consent administrator 208, the response handler 222, the data aggregator 214, the controller 250, the image capture device 104, or the client 220. For example, the rules generator 204 can generate a set of instructions to provide to the data aggregator 214 indicating a type of the biometric data 228 that cannot be collected, and the data aggregator 214 can perform actions to prevent the collection of the indicated type of the biometric data 228.

The rules generator 204 can identify the rules according to a schedule. In some implementations, the rules generator 204 can identify or generate the rules 232 periodically, such as every hour or every day. In some implementations, the rules generator 204 can identify the rules responsive to receiving an update to the rules 232 by the server 216, the client 220, or another computing system. In some implementations, the rules generator 204 can identify the rules 232 responsive to the entity 110 entering the zone 106. For example, the rules generator 204 can identify the rules 232 responsive to an indication from the entity detector 206 that the entity 110 has entered or is within the zone 106.

The sensor system 200 can include at least one entity detector 206. The entity detector 206 can include any hardware or software configurable to determine if the entity 110 is within the zone 106, or the presence of the entity 110 within the zone 106. In this manner, the collection of biometric data for entities can be subject to the rules 232 identified by the rules generator 204 when an entity of the entities is within the zone 106, thereby enabling a precise application of the rules by the sensor system 200. In some implementations, the entity detector 206 operates on at least some images or sensor data captured by the image capture device 104 and/or the sensors 108.

The entity detector 206 can determine the zone 106 by identifying a boundary, perimeter, or volume of the zone 106. In some implementations, the entity detector 206 can perform image recognition by processing elements of images captured by the image capture device 104, such as pixels or group of pixels, to determine the zone 106. For example, the entity detector 206 can perform edge detection, object detection, or line tracking processes on the captured images to establish the zone 106. For example, the entity detector 206 can identify features such as colors, shapes, edges, contrast between pixels, and spatial relationships between pixels. Determining the zone can include or refer to identifying the perimeter of the zone 106 and/or identifying a presence within the zone 106. In some implementations, the entity detector 206 can determine the zone 106 based on the sensors 108. The sensors 108 can indicate or detect the zone 106. For example, one or more passive infrared sensors (PIR) can establish a perimeter of the zone 106 based on a view of the one or more PIR sensors 108.

The entity detector 206 can determine if the entity 110 is within the zone 106. The entity detector 206 can determine if the entity 110 is fully within, partially within, on a perimeter of, exiting, or entering the zone 106. In some implementations, the entity detector 206 can identify a presence of the entity 110 within the zone using the sensors 108. For example, the sensors 108 can include PIR sensors 108. Upon the entity 110 passing the zone 106 indicated by the PIR sensors 108, the PIR sensors can detect a change in temperature indicative of an entity 110. As an illustrative example, the sensors 108 can include ultrasonic sensors 108. The ultrasonic sensors 108 can detect motion within the zone 106 and can transmit an indication or measurement of the motion to the entity detector 206. The entity detector 206 can determine from the indication that the entity is within the zone 106. The entity detector 206 can determine that the entity 110 is within the zone 106 based on a sound detection within the zone 106. For example, the entity detector 206 can detect, by the sensors 108, a sound corresponding to a human voice.

In some implementations, the entity detector 206 can determine if the entity 110 is within the zone based on the field of view of the image capture device 104. For example, the field of view of the image capture device 104 can be within the zone 106. If the entity 110 enters the field of view of the image capture device 104, the entity detector 206 can identify the entity 110 as being within the zone 106. In some implementations, the entity detector 206 can detect the entity 110 within the zone by operating spatial filters, segmentation, or machine learning models trained to detect objects. For example, the entity detector 206 can perform image recognition techniques to determine if the entity 110 has entered, exited, or is currently within the zone 106.

The entity detector 206 can determine if a detection by the sensors 108 indicates the entity 110 is within the zone by determining that the detection corresponds to the biometric data 228. In some implementations, a non-entity object (e.g., the object 112) can enter the zone. The object 112 may trigger a detection by the sensors 108 or a determination by the entity detector 206. For example, the sensors 108 may detect motion, a change in temperature, a change in moisture, a sound, or another such attribute. The entity detector 206 can determine, based on at least one of the sensor detection or image recognition techniques, that the non-entity object 112 is not the entity 110. For example, a ball can roll into the zone 106 and trigger a motion, temperature, optical, or other such detection by the sensors 108. The entity detector 206 can determine that the ball is not the entity 110 by, for example, determining that the ball is not within a threshold entity temperature, a threshold entity shape or height, or a threshold entity reflectivity, among others. The entity detector 206 can determine that the ball is not the entity 110 by, for example, performing facial recognition, gait recognition, or another form of image recognition to identify features associated with biometric data of an entity, such as a face, gait, body, among others.

The sensor system 200 can include at least one consent administrator 208. The consent administrator 208 can include any hardware or software configurable to determine if the entity 110 identified as being within the zone 106 by the entity detector 206 is associated with a consent 234 to collect the biometric data. The consent administrator 208 can maintain a profile 236 associated with the entity 110 to store and update the consent 234 of the entity 110.

The consent administrator 208 can identify if the entity 110 is associated with consent 234. The consent 234 can be or refer to a consent to collect the biometric data of the entity 110. The consent 234 can indicate a denial, acceptance, and/or conditions for the collection of the biometric data of the entity 110. The consent 234 can correspond to collection of the biometric data 228 within the zone 106. The entity 110 can be associated with a consent for each zone of the zones 106 the entity 110 has entered. In some implementations, a consent associated with the entity 110 can correspond to more than one zone 106. In some implementations, the entity 110 can have provided the consent 234 to collect the biometric data 228 during a prior entrance to the zone 106. In some implementations, the entity 110 can provide the consent 234 to collect the biometric data 228 prior to entering the zone 106, such as from home or another location.

In some implementations, the consent administrator 208 can generate the profile 236 for the entity 110 to store the consent 234. The consent administrator 208 can generate the profile 236 for the entity 110 responsive to a determination that no profile exists for the entity 110. The consent administrator 208 can maintain the consent 234 associated with the entity 110 in the profile. For example, the consent administrator 208 can update the consent 234 associated with the profile responsive to updates from the client 220, the monitor 102, the server 216, or the response handler 222, among others. The profile 236 can store information related to the consent 234 associated with the entity 110, such as conditions for collection of the biometric data 228.

In some implementations, the consent 234 can indicate conditions for collection of the biometric data 228 for the entity 110. The conditions can indicate a duration for collection of the biometric data 228, a time period in which the biometric data 228 can be collected, a type of biometric data 228, or an allowable usage of the collected biometric data 228, among others. For example, the consent 234 associated with the entity 110 can indicate that the entity 110 has not agreed to facial recognition processing on images captured of the entity 110. For example, the consent 234 associated with the entity 110 can indicate that the entity 110 has agreed to retinal scanning. For example, the consent 234 associated with the entity 110 can indicate that the entity 110 has not agreed to a third-party transfer of the collected biometric data 228 associated with the entity 110. In some implementations, the profile 236 can indicate that the entity accepts some, none, or all of the collection of the biometric data 228. For example, the consent 234 associated with the profile 236 of the entity can indicate that the entity 110 has indicated conditions for the collection of the entity's biometric data 228.

The consent administrator 208 can determine if the entity 110 is associated with a consent 234. In some implementations, the consent administrator 208 can determine that a profile 236 including the consent 234 is stored in the data repository 224. The consent administrator 208 can determine that the entity 110 is associated with a profile using the image recognition techniques depicted herein. For example the consent administrator 208 can determine that a face of the entity 110 matches a face of an entity 110 associated with a profile 236. The consent administrator 208 can determine that the entity 110 is associated with a profile 236 via a lookup of an identifier of the entity 110 within a database of the profiles 236. For example, the entity 110 may swipe a badge, key in a PIN, provide a passcode, or provide another identifier within the zone 106 by which the consent administrator 208 can identify the profile 236. The consent administrator 208 can determine that the entity 110 is associated with a profile 236 by a detection of a client 220 (such as a smartphone) associated with the entity 110.

The consent administrator 208 may not associate a consent 234 with the entity 110. In some implementations, the entity 110 may not be associated with the consent 234 upon a first entrance to the zone 106. In some implementations, the entity 110 may not have provided a consent 234 to the sensor system 200. The entity 110 may not be associated with a profile 236. The entity 110 may not be associated with the profile 236 upon a first entrance to the zone 106. The entity 110 may have denied consent or provided a condition during a prior entrance to the zone 106 indicating that the consent administrator 208 is not to generate or maintain a profile 236 for the entity 110.

The sensor system 200 can include at least one request provider 210. The request provider 210 can include any hardware or software configurable to generate a request for the consent 234 for the collection of the biometric data 228. The request provider 210 can generate a set of instructions to present the request. The request provider 210 can present the request to the entity 110 based on the set of instructions. The request provider 210 can generate the request based on the rules 232 identified by the rules generator 204 for the collection of the biometric data 228.

The request provider 210 can generate a request for the consent 234 for the collection of the biometric data 228. The request provider 210 can generate the request based on the rules 232. For example, the rules 232 can indicate attributes of the request such as a duration of the presentation of the request, information to include within the request, or characteristics of the presentation of the request. Characteristics of the presentation of the request can include a medium of the presentation (e.g., audio, visual), a style of the presentation (e.g., color, volume, font size), or a device through which to present the request. For example, the request provider 210 can generate the request and transmit the request to the client 220 for presentation.

In some implementations, the request provider 210 generating the request can include the request provider 210 transmitting the request for presentation. The request can include a set of instructions for the presentation of the request. Generating the request can include the request provider 210 generating the set of instructions for the presentation of the request. The request provider 210 can cause the monitor 102 or the client 220 to generate auditory signals for playback through a loudspeaker via the set of instructions. The request provider 210 can provide recorded audio for playback via a loudspeaker to request consent for the collection of the biometric data.

In some implementations, the request can include the instructions for presentation to cause the request to present on the client 220. The instructions can cause the client 220 to present the request on the display 240 through the application 248. For example, the instructions can cause the request to present as a message on the display 240 of the client. The instructions can include visual, auditory, haptic, or a combination thereof characteristics of the request. For example, the instructions can cause the client 220 to vibrate upon receipt of the request. For example, the instructions can cause the request to present as a text-based message on the display of the client 220. For example, the instructions can cause the client 220 to play the request with a specified volume, vocal tone, or other auditory characteristics through a speaker coupled with the client 220.

In some implementations, the request provider 210 can transmit the request to the monitor 102 for presentation. The request provider 210 can provide the request for visual, auditory, haptic, or a combination thereof presentation through the monitor 102. For example, the request provider 210 can generate instructions for playback of the request via the monitor 102 including a volume of the request, a tone of the request, or a message of the request. For example, the request provider 210 can generate the set of instructions to cause the monitor 102 to present the request according to a set of visual characteristics, such as size, font style, or color.

In some implementations, the request can identify the entity 110. The request may include a video, image, or other capture of the entity 110 from the image capture device 104. The request may cause the client 220 or the monitor 102 to present the capture of the entity 110 to the entity 110. In some implementations, the request can include an identifier of the entity 110, such as a name, employee number, social security number, or other such identifiers. For example, the request provider 210 can receive an employee number of the entity 110 from the consent administrator 208 and may present the employee number to the entity 110.

In some implementations, the request can include a presentation of a description of the collection of the biometric data 228. The description of the collection of the biometric data 228 can include the type of biometric data to be collected, the processing of the biometric data 228 to be collected, the duration of the collection of the biometric data 228, or the rules 232 for the collection of the biometric data, among others. The request can provide the rules 232 for presentation to the entity 110. For example, the application 248 operating on the client 220 may present the rules 232 to the entity via the display 240. The application 248 may present a subset of the rules 232. For example, the application 248 or the monitor 102 can present the rules 232 which apply to the specific entity 110 in the zone 106 and may not present rules which do not apply to the specific entity 110. In this manner, the entity 110 can be made abreast of the biometric data 228 to be collected and the rules 232 for collecting their biometric data 228 to make an information decision on the consent 234.

In some implementations, the request can include options for a selection related to the consent 234. In some implementations, the selection can include an acceptance of the request, a denial of the request, or a selection of one or more conditions related to the consent 234 to accept or deny. The request provider 210 can generate the request to cause the client 220 or the monitor 102 to present one or more options to the entity 110 to make selections related to the consent 234. For example, the application 248 can generate one or more user-interface elements based on the instructions in the request generated by the request provider 210. The entity 110 can provide input via the user input device 244 to accept, deny, or make selections of the conditions for the consent 234. For example, the monitor 102 can present an auditory list of options regarding the conditions for the consent 234 to the entity 110. The entity 110 can make a selection related to the consent 234 through an input device coupled with the monitor 102 or the client 220 (e.g., the user input device 244). Making a selection can cause the application 248 or the monitor 102 to transfer a response indicating the consent 234.

The response handler 222 can receive a response indicating the consent 234. The response can indicate acceptance of the request for the consent 234, denial of the request for the consent 234, conditions for the request for the consent 234, or a combination thereof. The response can include one or more selections made by the entity 110 related to the consent 234. For example, the response can include a selection indicating a type of biometric data 228 indicated as accepted by the entity 110 and/or a second type of biometric data 228 indicated as denied by the entity 110. For example, the response can include a selection indicating a duration for the collection of the biometric data 228.

In some implementations, the client 220 or the monitor 102 can transmit the response. The client 220 can transmit the response via the application 248 operating thereon. For example, the entity 110 can interact with the user input device 244 to make one or more selections related to the consent 234 and the client 220 can transmit the response via the network 212. In some implementations, the monitor 102 can transmit the response. The monitor 102 can include a user input device (similar to the user input device 244) to accept an interaction with the entity 110 or other users to provide the one or more selections related to the consent 234. The monitor 102 can transmit the response including the one or more selections to the response handler 222.

In some implementations, the response handler 222 can receive the response from a monitoring of the entity 110. The image capture device 104 can provide one or more images to the response handler. The one or more images can include the entity 110. The request provider 210 can determine, from the one or more images including the entity 110 and using image recognition techniques described herein, a response indicating acceptance, denial, or conditions associated with the request for the consent 234 to collect the biometric data 228. For example, the response handler 222 can determine from the images a behavior indicative of acceptance, such as the entity 110 nodding his head, mouthing “yes,” saying aloud “I accept,” or giving a thumb's up, among others. For example, the request provider 210 can determine from the images a behavior indicative of denial, such as the entity 110 shaking his head, mouthing “no,” saying aloud “I do not accept,” or giving a thumb's down, among others.

The response handler 222 can transmit the response including an indication of the acceptance, denial, or partial acceptance or denial of the consent 234 to other components of the sensor system 200. For example, the response handler 222 can transmit the response to the consent administrator 208. The consent administrator 208 can update the profile 236 associated with the entity 110 to include the consent 234 received from the entity 110. For example, the response handler 222 can transmit the response to the data aggregator 214.

The sensor system 200 can include at least one data aggregator 214. The data aggregator 214 can include any hardware or software configurable to generate instructions for the collection of the biometric data 228. The data aggregator 214 can determine, based on at least one of the consent 234 or the rules 232, instructions for the collection of the biometric data 228. The data aggregator 214 can provide the instructions to a controller to capture the biometric data 228 according to the instructions based on at least the rules 232 or the consent 234.

The data aggregator 214 can determine to collect or prevent the collection of the biometric data 228 for the entity 110. In some implementations, the data aggregator 214 can determine that the consent 234 provided by the entity 110 indicates acceptance of the request to collect the biometric data 228. The data aggregator 214 can generate instructions for the collection of the biometric data 228 according to the rules. For example, upon receiving an acceptance of the request, the data aggregator 214 can generate the instructions to cause the collection of the biometric data according to the rules 232 identified from the zone 106 by the rules generator 204. In some implementations, the data aggregator 214 can determine that the consent 234 provided by the entity 110 indicates a denial of the request to collect the biometric data 228. The data aggregator 214 can generate the instructions for the collection of the biometric data 228 according to the consent indicating the denial. For example, the data aggregator 214 can generate instructions to prevent the collection of the biometric data 228 for the entity 110 within the zone 106. The data aggregator 214 can generate the instructions based on conditions indicated in the consent 234. For example, the data aggregator 214 can generate the instructions for collection of the biometric data 228 to include a collection of a portion of the biometric data 228 according to the rules 232 and a prevention of the collection of a second portion of the biometric data 228 according to the consent 234. In this manner, the denial of consent by the entity 110 can supersede the rules 232 for determination of the collection of the biometric data 228 for the entity.

Preventing the collection of the biometric data 228 can refer to the data aggregator generating the instructions to prevent at least one of image processing, image storage, biometric data storage, biometric data or image transmittal, or image capture. For example, the data aggregator 214 can generate the instructions to cause the image capture device 104 to stop capturing images for a period of time or for a zone. For example, the data aggregator 214 can generate the instruction to cause the image capture device 104 to block, blur, censor, or otherwise remove the entity 110 from the images captured by the image capture device. In some implementations, the data aggregator 214 can tag one or more images including the entity 110 according to the instructions. For example, the data aggregator 214 can tag the images to indicate a period of storage, to delete the images, to mark the images as non-transferrable, or to mark the images to prevent certain image recognition techniques, among others. The data aggregator 214 can store the images and the biometric data within the profile 236 of the respective entity 110.

The data aggregator 214 can indicate a period of time for the collection of the biometric data or a frequency for the collection of the biometric data 228. For example, the data aggregator 214 can generate the instructions to cause image capture device 104 to capture the images every 10 seconds, one minute, or other interval of time. For example, the data aggregator 214 can generate the instructions to cause the image capture device 104 to perform image recognition on a subset of the captured images and/or to perform the image recognition at an interval of time. The data aggregator 214 can transmit the instructions for the collection of the biometric data 228 to the controller 250.

The sensor system 200 can include at least one controller 250. The controller 250 can include any hardware or software configurable to control operations of the image capture device 104. The controller 250 can communicate with the image capture device 104 via the network 212, or the controller 250 can be coupled with or disposed within the image capture device 104. The controller 250 can control operations of the image capture device 104, such as shutter speed, exposure, frame rate, resolution, or image capture. The controller 250 can instruct, actuate, or otherwise cause the image capture device 104 to capture images. In some implementations, the controller 250 can instruct the image capture device 104 to capture the images periodically or responsive to a trigger event. A trigger event can include receipt of the response indicating the consent 234, the entity 110 entering or exiting the zone 106, an update to the rules 232, or receipt of the instructions for the collection of the biometric data from the data aggregator 214, among others.

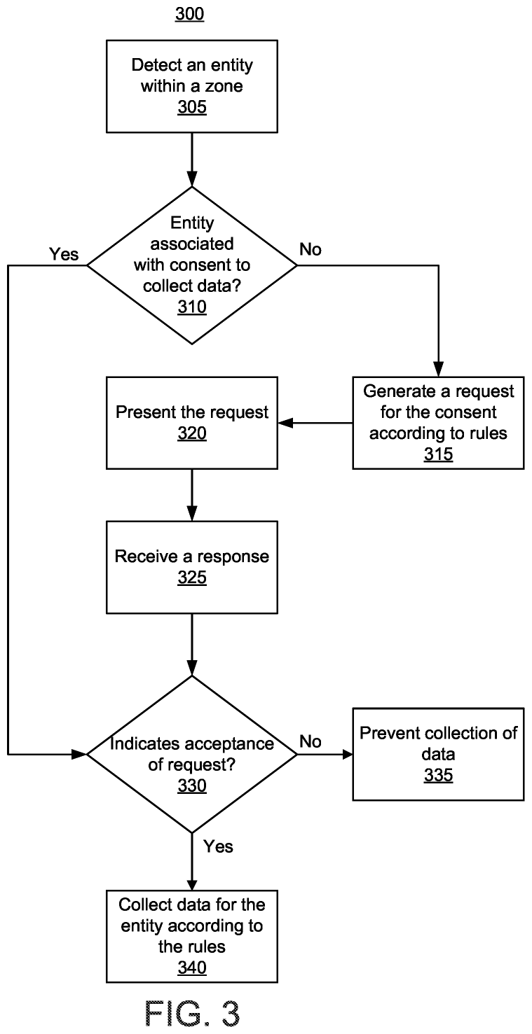

FIG. 3 depicts an example of a method 300 of processing consent for collection of biometric data according to rules; such as visual and/or computer vision-based collection of biometric data. The method 300 can correspond to any of the systems or methods depicted in the FIGS. 1, 2, and/or 4A and 4B. Any of the steps depicted with reference to FIG. 3 can be performed by any component of the system, such as any of the components of the sensor system 200 depicted in FIG. 2. and in any order. Furthermore the method 300 can include steps not depicted herein.

At STEP 305, the sensor system can detect an entity within a zone. The sensor system can include a zone within the field of view of the image capture device. The image capture device can capture an image of an entity within the zone, or the one or more sensors of the image capture device can detect a measurement indicative of an entity within the zone. The entity detector can determine, from the images and/or detected measurements, that the entity has entered or is within the zone.

At STEP 310, the consent administrator can determine if the entity is associated with a consent to collect his biometric data. The consent administrator can generate a profile associated with the entity, or the consent administrator can access an existing profile associated with the entity to determine if the entity is associated with a consent. The consent administrator can determine if a consent provided by the entity accepts, denies, or a combination thereof (indicated by the conditions specified in the consent) the collection of the biometric data of the entity. If the consent administrator determines that the entity is associated with a consent to collect the biometric data, the sensor system can proceed to STEP 330. If the consent administrator determines that the entity is not associated with a consent to collect the biometric data, the sensor system can proceed to STEP 315.

At 315, the request provider can generate a request for the consent according to rules. The request provider can generate the request according to the rules for the collection of the biometric data. The rules for the collection of the biometric data can be identified by the sensor system, such as by the rules generator. The request provider can generate the request to include one or more of the rules, a description of the collection of the biometric data, or an identifier of the entity, among others. The request provider can generate the request for presentation in one or more mediums, for one or more durations, or with one or more visual, haptic, or auditory effects.

At 320, the request provider can present the request. The request provider can present the request via at least one of the image capture device, the monitor, or the client. The request provider can present the request according to the rules. For example, the request provider can present the request in a language (e.g., Spanish, French), indicated by the rules, a medium (e.g., visual, audio, or haptic), or other presentation effects.

At 325, the response handler can receive a response. The response handler can receive a response from at least one of the image capture device, the client, or the monitor. For example, the entity can provide the response via the application operating on the client. For example, the response handler can receive the response from the image capture device monitoring the entity. The response can include the consent. The response can include the consent indicating an acceptance, denial, or combination thereof of the request to collect the biometric data.

At 330, the response handler can determine if the response indicates an acceptance of the request. The response handler can determine from the response if the request indicates an acceptance of the request for the consent to collect the biometric data. The response handler can determine if the consent indicates an acceptance of a portion of the collection of the biometric data. The response handler can identify, from the images captured by the image capture device, that the entity accepts the request. The response handler can identify, from input provided by the entity, that the entity accepts the request for consent. Upon a determination that the consent indicates an acceptance of the collection of the biometric data or a portion of the biometric data, the sensor system can proceed to STEP 340. Upon a determination that the response does not indicate an acceptance of the request for the consent to collect the biometric data, the sensor system can proceed to STEP 335.

At 335, the data aggregator can prevent collection of the biometric data. The data aggregator can prevent the collection of the biometric data according to at least one of the rules or the consent. The data aggregator can prevent the collection of a subset of the biometric data, according to at least one of the rules or the consent. The data aggregator can prevent the collection of the biometric data by generating instructions according to the consent and/or the rules for capture of the images, processing of the images and biometric data, storage of the images and biometric data, transmittal of the images and biometric data, among others.

At 340, the data aggregator can collect data for the entity according to the rules. The data aggregator can collect the data based on the rules and/or the consent for the entity within the zone. The data aggregator can collect the data at predetermined intervals, or responsive to a detected event, such as the entity entering a door or speaking with another person. The data aggregator can store the biometric data and/or the images in the data repository.

FIGS. 4A and 4B depict an example of a computing environment 400 that can be used to implement any of various systems, devices, and methods described herein, such as the sensor system 200 or components thereof. The computing environment 400 can be used to implement any of various sensor systems, image processing systems, security systems, video monitoring systems, or various combinations thereof.

As shown in FIGS. 4A and 4B, each computing device 400 includes a central processing unit 421, and a main memory unit 422. As shown in FIG. 4A, a computing device 400 can include a storage device 428, an installation device 416, a network interface 418, an I/O controller 423, display devices 424a-424n, a keyboard 426 and a pointing device 427, e.g. a mouse. The storage device 428 can include, without limitation, an operating system, software, and software of the system 200. As shown in FIG. 4B, each computing device 400 can also include additional optional elements, e.g. a memory port 403, a bridge 470, one or more input/output devices 430a-430n (generally referred to using reference numeral 430), and a cache memory 440 in communication with the central processing unit 421.

The central processing unit 421 is any logic circuitry that responds to and processes instructions fetched from the main memory unit 422. In many implementations, the central processing unit 421 is provided by a microprocessor unit. The computing device 400 can be based on any of various processors capable of operating as described herein. The central processing unit 421 can utilize instruction level parallelism, thread level parallelism, different levels of cache, and multi-core processors. A multi-core processor can include two or more processing units on a single computing component.

Main memory unit 422 can include one or more memory chips capable of storing data and allowing any storage location to be directly accessed by the microprocessor 421. Main memory unit 422 can be volatile and faster than storage 428 memory. Main memory units 422 can be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some implementations, the main memory 422 or the storage 428 can be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 422 can be based on any of the above described memory chips, or any other available memory chips capable of operating as described herein. In the implementation shown in FIG. 4A, the processor 421 communicates with main memory 422 via a system bus 450 (described in more detail below). FIG. 4B depicts an implementation of a computing device 400 in which the processor communicates directly with main memory 422 via a memory port 403. For example, in FIG. 4B the main memory 422 can be DRDRAM.

FIG. 4B depicts an implementation in which the main processor 421 communicates directly with cache memory 440 via a secondary bus, sometimes referred to as a backside bus. In other implementations, the main processor 421 communicates with cache memory 440 using the system bus 450. Cache memory 440 typically has a faster response time than main memory 422 and is typically provided by SRAM, BSRAM, or EDRAM. In the implementation shown in FIG. 4B, the processor 421 communicates with various I/O devices 430 via a local system bus 450. Various buses can be used to connect the central processing unit 421 to any of the I/O devices 430, including a PCI bus, a PCI-X bus, or a PCI-Express bus, or a NuBus. For implementations in which the I/O device is a video display 424, the processor 421 can use an Advanced Graphics Port (AGP) to communicate with the display 424 or the I/O controller 423 for the display 424. FIG. 4B depicts an implementation of a computer 400 in which the main processor 421 communicates directly with I/O device 430b or other processors 421′ via HYPERTRANSPORT, RAPIDIO, or INFINIBAND communications technology. FIG. 4B also depicts an implementation in which local busses and direct communication are mixed: the processor 421 communicates with I/O device 430a using a local interconnect bus while communicating with I/O device 430b directly.

A wide variety of I/O devices 430a-430n can be present in the computing device 400. Input devices can include keyboards, mice, trackpads, trackballs, touchpads, touch mice, multi-touch touchpads and touch mice, microphones (analog or MEMS), multi-array microphones, drawing tablets, cameras, single-lens reflex camera (SLR), digital SLR (DSLR), CMOS sensors, CCDs, accelerometers, inertial measurement units, infrared optical sensors, pressure sensors, magnetometer sensors, angular rate sensors, depth sensors, proximity sensors, ambient light sensors, gyroscopic sensors, or other sensors. Output devices can include video displays, graphical displays, speakers, headphones, inkjet printers, laser printers, and 3D printers.

Devices 430a-430n can include a combination of multiple input or output devices. Some devices 430a-430n allow gesture recognition inputs through combining some of the inputs and outputs. Some devices 430a-430n provides for facial recognition which can be utilized as an input for different purposes including authentication and other commands. Some devices 430a-430n provides for voice recognition and inputs.

Additional devices 430a-430n have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices can have larger surfaces, such as on a table-top or on a wall, and can also interact with other electronic devices. Some I/O devices 430a-430n, display devices 424a-424n or group of devices can be augmented reality devices. The I/O devices can be controlled by an I/O controller 421 as shown in FIG. 4A. The I/O controller 421 can control one or more I/O devices, such as, e.g., a keyboard 426 and a pointing device 427, e.g., a mouse or optical pen. Furthermore, an I/O device can also provide storage and/or an installation medium 416 for the computing device 400. The computing device 400 can provide USB connections (not shown) to receive handheld USB storage devices. An I/O device 430 can be a bridge between the system bus 450 and an external communication bus, e.g. a USB bus, a SCSI bus, a FireWire bus, an Ethernet bus, a Gigabit Ethernet bus, a Fibre Channel bus, or a Thunderbolt bus.

Display devices 424a-424n can be connected to I/O controller 421. Display devices can include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays can use, e.g. stereoscopy, polarization filters, active shutters, or autostereoscopy. Display devices 424a-424n can also be a head-mounted display (HMD). In some implementations, display devices 424a-424n or the corresponding I/O controllers 423 can be controlled through or have hardware support for graphics libraries.

In some implementations, the computing device 400 can include or connect to multiple display devices 424a-424n, which each can be of the same or different type and/or form. As such, any of the I/O devices 430a-430n and/or the I/O controller 423 can include any type and/or form of suitable hardware, software, or combination of hardware and software to support, enable or provide for the connection and use of multiple display devices 424a-424n by the computing device 400. For example, the computing device 400 can include any type and/or form of video adapter, video card, driver, and/or library to interface, communicate, connect or otherwise use the display devices 424a-424n. In one implementation, a video adapter can include multiple connectors to interface to multiple display devices 424a-424n. The computing device 400 can include multiple video adapters, with each video adapter connected to one or more of the display devices 424a-424n. In some implementations, any portion of the operating system of the computing device 400 can be configured for using multiple displays 424a-424n. One or more of the display devices 424a-424n can be provided by one or more other computing devices 400a or 400b connected to the computing device 400, via the network 440. Software can be designed and constructed to use another computer's display device as a second display device 424a for the computing device 400. For example, a tablet or other portable electronic device can connect to a computing device 400 and use the display of the device 400 as an additional display screen that can be used as an extended desktop.

Referring again to FIG. 4A, the computing device 400 can comprise a storage device 428 (e.g. one or more hard disk drives or redundant arrays of independent disks) for storing an operating system or other related software, and for storing application software programs such as any program related to the software for the system 200. Examples of storage device 428 include, e.g., hard disk drive (HDD); optical drive including CD drive, DVD drive, or BLU-RAY drive; solid-state drive (SSD); USB flash drive; or any other device suitable for storing data. Some storage devices can include multiple volatile and non-volatile memories, including, e.g., solid state hybrid drives that combine hard disks with solid state cache. Some storage device 428 can be non-volatile, mutable, or read-only. Some storage device 428 can be internal and connect to the computing device 400 via a bus 450. Some storage device 428 can be external and connect to the computing device 400 via a I/O device 430 that provides an external bus. Some storage device 428 can connect to the computing device 400 via the network interface 418 over a network. Some client devices 400 can not require a non-volatile storage device 428 and can be thin clients or zero clients 402. Some storage device 428 can also be used as an installation device 416, and can be suitable for installing software and programs.

Computing device 400 can also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. Computing device 400 install software or applications from a source (e.g., server) maintained by a proprietor of the software or applications, such as a source independent of an application distribution platform.

Furthermore, the computing device 400 can include a network interface 418 to interface to the network 440 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one implementation, the computing device 400 communicates with other computing devices 400′ via any type and/or form of gateway or tunneling protocol e.g. Secure Socket Layer (SSL) or Transport Layer Security (TLS). The network interface 418 can comprise a built-in network adapter, network interface card, PCMCIA network card, EXPRESSCARD network card, card bus network adapter, wireless network adapter, USB network adapter, modem or any other device suitable for interfacing the computing device 400 to any type of network capable of communication and performing the operations described herein.

A computing device 400 of the sort depicted in FIG. 4A can operate under the control of an operating system, which controls scheduling of tasks and access to system resources. The computing device 400 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein.

The computer system 400 can be any workstation, telephone, desktop computer, laptop or notebook computer, netbook,, tablet, server, handheld computer, mobile telephone, smartphone or other portable telecommunications device, media playing device, a gaming system, mobile computing device, or any other type and/or form of computing, telecommunications or media device that is capable of communication. The computer system 400 has sufficient processor power and memory capacity to perform the operations described herein. In some implementations, the computing device 400 can have different processors, operating systems, and input devices consistent with the device.

In some implementations, the communications device 400 includes a combination of devices, e.g. a smartphone combined with a digital audio player or portable media player. For example, one of these implementations is a smartphone. The communications device 400 can be a laptop or desktop computer equipped with a web browser and a microphone and speaker system, e.g. a telephony headset. The communications devices 400 can be web-enabled and can receive and initiate phone calls. In some implementations, a laptop or desktop computer is also equipped with a webcam or other video capture device that enables video chat and video call.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, soc (system on chip), som (system on module) or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary implementations, and that such variations are intended to be encompassed by the present disclosure.

What is claimed is:

1. A system, comprising:
one or more processors coupled with memory, configured to:
determine, via an image capture device comprising one or more sensors, that an entity is within a zone;
determine that the entity is not associated with a consent to collect biometric data of the entity;
generate a request for the consent to collect the biometric data according to rules associated with the zone;
present the request for the consent to collect the biometric data;
receive, from at least one of monitoring of the entity or a device associated with the entity, a response indicating acceptance of the request for the consent to collect the biometric data; and
aggregate the biometric data according to the rules responsive to receiving the acceptance.

2. The system of claim 1, comprising the one or more processors to:
determine, via the image capture device, that a second entity comprising second biometric data is within the zone;
identify that the second entity is associated with an acceptance of a second request for the consent to collect the biometric data; and
aggregate the second biometric data, responsive to identifying the acceptance of the second request, for periods corresponding to the entity being within the zone.

3. The system of claim 1, comprising the one or more processors to:
determine, via the image capture device, that a second entity comprising second biometric data is within the zone;
identify that the second entity is associated with a denial of a second request for the consent to collect the biometric data; and
prevent a collection of the second biometric data responsive to identifying the denial of the second request.

4. The system of claim 1, comprising the one or more processors to:
generate, responsive to receiving the response indicating the acceptance of the request for the consent to collect the biometric data, a profile associated with the entity; and
store the aggregated biometric data in the memory according to the rules.

5. The system of claim 1, comprising the one or more processors to:
identify, responsive to determining that the entity is not associated with the consent to collect the biometric data of the entity, that a condition for collecting the biometric data is satisfied, the condition comprising at least one of an age of the entity, a profile associated with the entity, or a location associated with the entity.

6. The system of claim 1, comprising the one or more processors to:
aggregate the biometric data according to the rules comprising at least one of: a rule based on a locality of the zone, a rule based on a type of the biometric data, a rule based on a time period of aggregation of the biometric data, a rule based on a storage of the biometric data, or a rule based on the processing of the biometric data.

7. The system of claim 1, comprising the one or more processors to:
present the request for the consent to collect the biometric data to the entity via a loudspeaker according to a set of parameters defining at least one of a volume of the request, a vocal pattern of the request, a duration of the presentation of the request, or a language of the request.

8. The system of claim 1, comprising the one or more processors to:
present the request for the consent to collect the biometric data to the entity via an application operating on the device according to a set of parameters defining at least one of a duration of the presentation of the request, an inclusion in the request of a description of usage of the biometric data, or a display characteristic.

9. The system of claim 1, comprising the one or more processors to:
aggregate the biometric data comprising a retina or iris scan, fingerprint, voiceprint, or scan of hand or face geometry using the image capture device.

10. The system of claim 1, comprising the one or more processors to:
generate the rules using at least one of user input or data received from a remote database;
present the rules on a display device associated with the one or more processors; and
validate the rules responsive to receiving an interaction accepting the rules.

11. A method, comprising:
determining, by one or more processors coupled with memory, via an image capture device comprising one or more sensors, that an entity is within a zone;
determining, by the one or more processors, that the entity is not associated with a consent to collect biometric data of the entity;
generating, by the one or more processors, a request for the consent to collect the biometric data according to rules associated with the zone;
presenting, by the one or more processors, the request for the consent to collect the biometric data;
receiving, by the one or more processors, from at least one of monitoring of the entity or a device associated with the entity, a response indicating acceptance of the request for the consent to collect the biometric data; and
aggregating, by the one or more processors, the biometric data according to the rules responsive to receiving the acceptance.

12. The method of claim 11, comprising:
determining, by the one or more processors via the image capture device, that a second entity comprising second biometric data is within the zone;
identifying, by the one or more processors, that the second entity is associated with an acceptance of a second request for the consent to collect the biometric data; and
aggregating, by the one or more processors, the second biometric data, responsive to identifying the acceptance of the second request, for periods corresponding to the entity being within the zone.

13. The method of claim 11, comprising:
determining, by the one or more processors, via the image capture device, that a second entity comprising second biometric data is within the zone;
identifying, by the one or more processors, that the second entity is associated with a denial of a second request for the consent to collect the biometric data; and
preventing, by the one or more processors, a collection of the second biometric data responsive to identifying the denial of the second request.

14. The method of claim 11, comprising:
generating, by the one or more processors, responsive to receiving the response indicating the acceptance of the request for the consent to collect the biometric data, a profile associated with the entity; and
storing, by the one or more processors, the aggregated biometric data in the memory according to the rules.

15. The method of claim 11, comprising:
identifying, by the one or more processors, responsive to determining that the entity is not associated with the consent to collect the biometric data of the entity, that a condition for collecting the biometric data is satisfied, the condition comprising at least one of an age of the entity, a profile associated with the entity, or a location associated with the entity.

16. The method of claim 11, comprising:
aggregating, by the one or more processors, the biometric data according to the rules comprising at least one of: a rule based on a locality of the zone, a rule based on a type of the biometric data, a rule based on a time period of aggregation of the biometric data, a rule based on a storage of the biometric data, or a rule based on the processing of the biometric data.

17. The method of claim 11, comprising:
presenting, by the one or more processors, the request for the consent to collect the biometric data to the entity via a loudspeaker according to a set of parameters defining at least one of a volume of the request, a vocal pattern of the request, a duration of the presentation of the request, or a language of the request.

18. The method of claim 11, comprising:
presenting, by the one or more processors, the request for the consent to collect the biometric data to the entity via an application operating on the device according to a set of parameters defining at least one of a duration of the presentation of the request, an inclusion in the request of a description of usage of the biometric data, or a display characteristic.

19. An image capture device, comprising:
one or more sensors; and
one or more processors coupled with memory, configured to:
determine that an entity is within a zone;
determine that the entity is not associated with a consent to collect biometric data of the entity;
generate a request for the consent to collect the biometric data according to rules associated with the zone;
present the request for the consent to collect the biometric data;
receive, from at least one of monitoring of the entity or a device associated with the entity, a response indicating acceptance of the request for the consent to collect the biometric data; and
aggregate the biometric data according to the rules responsive to receiving the acceptance.

20. The image capture device of claim 19, wherein the one or more processors are configured to:
determine that a second entity comprising second biometric data is within the zone;
identify that the second entity is associated with an acceptance of a second request for the consent to collect the biometric data; and
aggregate the second biometric data, responsive to identifying the acceptance of the second request, for periods corresponding to the entity being within the zone.
